(19) United States
(12) Patent Application Publication
(10) Pub. No.: US 2022/0234250 A1
(43) Pub. Date: Jul. 28, 2022

(54) METHOD FOR SEPARATING A PLURALITY OF SLICES FROM WORKPIECES DURING A NUMBER OF SEPARATING PROCESSES BY MEANS OF A WIRE SAW, AND SEMICONDUCTOR WAFER MADE OF MONOCRYSTALLINE SILICON

(71) Applicant: SILTRONIC AG, Munich (DE)

(72) Inventors: Georg PIETSCH, Burghausen (DE); Peter WIESNER, Reut (DE)

(73) Assignee: SILTRONIC AG, Munich (DE)

(21) Appl. No.: 17/613,688

(22) PCT Filed: Apr. 29, 2020
(86) PCT No.: PCT/EP2020/061893

§ 371 Date: Nov. 23, 2021

(30) Foreign Application Priority Data
May 27, 2019 (DE) 10 2019 207 719.6

(51) Int. Cl. B28D 5/04; B28D 5/00

(52) U.S. Cl. CPC B28D 5/045; B28D 5/0076

(57) ABSTRACT

Wafer shape parameters from prior runs of simultaneously slicing a plurality of wafers from a workpiece in a wire saw having a sawing wire tensioned between wire guide rolls are used to alter the temperature profile of fixed and a moveable bearings at the ends of at least one wire guide roll, resulting in wafers with low waviness.

### CROSS REFERENCE TO RELATED APPLICATIONS

This application is the U.S. National Phase of PCT Appln. No. PCT/EP2020/061893 filed Apr. 29, 2020, which claims priority to German Application No. 10 2019 207 719.6 filed May 27, 2019, the disclosures of which are incorporated in their entirety by reference herein.

### BACKGROUND OF THE INVENTION

### Field of the Invention

A subject of the invention is a method for slicing off a multiplicity of wafers from workpieces during a number of slicing operations by means of a wire saw which comprises a wire web of moving wire sections of a sawing wire which is stretched between two wire guide rollers, with each of the wire guide rollers being mounted between a fixed bearing and a movable bearing.

Another subject of the invention is a semiconductor wafer of monocrystalline silicon which is obtainable by the method.

### 2. DESCRIPTION OF THE RELATED ART

There are numerous applications where thin, uniform wafers of a material are needed. One example of wafers which are subject to particularly exacting requirements in terms of uniformity and plane-parallelism of their respective front and back sides are wafers of semiconductor material that are used as substrates for the fabrication of microelectronic components. Wire sawing, where a multiplicity of wafers are sliced off simultaneously from a workpiece, is particularly important in the production of such wafers, since it is particularly economical.

With wire sawing, sawing wire is guided spirally around at least two wire guide rollers in such a way that on the side of two adjacent wire guide rollers that faces the workpiece which is to be cut up, and which is bonded to a holding bar, a wire web is stretched which is composed of sawing wire sections extending parallel to one another. The wire guide rollers have the form of circular cylinders, the axes of these circular cylinders are arranged parallel to one another, and the cylindrical surfaces of the wire guide rollers possess a covering of a wear-resistant material, which is provided with annularly closed grooves which extend in planes perpendicular to the wire guide roller axis and which carry the sawing wire. Turning the wire guide rollers in the same direction about their cylindrical axes produces a movement of the wire sections of the wire web relative to the workpiece, and, by means of the contacting of workpiece and wire web in the presence of an abrasive, the wire sections thus perform removal of material. Through continued feeding of the workpiece, the wire sections form cutting kerfs in the workpiece and work through the workpiece until they all come to stop in the holding bar. The workpiece has then been cut up into a multiplicity of uniform wafers, which by means of the adhesive joint hang from the holding bar like teeth of a comb. Wire saws and methods for wire sawing are known, for example, from DE 10 2016 211 883 A1 or from DE 10 2013 219 468 A1.

Wire sawing may be accomplished by lap cutting or abrasive cutting. With lap cutting, working fluid in the form of a slurry of hard substances is supplied to the space between wire surface and workpiece. Removal of material is accomplished in the case of lap cutting by means of a three-body interaction between sawing wire, hard substances, and workpiece. With abrasive cutting, the sawing wire used has hard substances integrated firmly into its surface, and a working fluid supplied does not itself contain any abrasive substances, and acts as a cooling lubricant. Removal of material in the case of abrasive cutting then takes place by means of a two-body interaction between sawing wire with bonded hard substances and workpiece.

The sawing wire is usually piano wire made, for example, of hypereutectoid pearlitic steel. The hard substances of the slurry consist, for example, of silicon carbide (SiC) in a viscous carrier liquid, such as glycol or oil, for example. The bonded hard substance consists, for example, of diamond, which is bonded form- and force-fittingly to the wire surface by nickel electroplate or synthetic resin bonding or by being rolled in.

In the case of lap cutting, the sawing wire used is smooth or structured; in the case of abrasive cutting, only smooth sawing wire is used. A smooth sawing wire possesses the form of a circular cylinder of very great height (that is, the wire length). A structured sawing wire is a smooth wire which has been provided over its entire length with a multiplicity of protuberances and indentations in directions perpendicular to the longitudinal wire direction. An example of smooth sawing wire for lap cutting is described by WO 13053622 A1, an example of structured sawing wire for lap cutting by U.S. Pat. No. 9,610,641 B2, and an example of smooth sawing wire with diamond covering for abrasive cutting by U.S. Pat. No. 7,926,478 B2.

With customary wire saws, each of the wire guide rollers is mounted, in each case in the vicinity of one of its end faces, with a bearing which is joined firmly to the frame of the machine and is termed a fixed bearing, and, in the vicinity of the opposite end face, with a bearing which is movable in the axial direction of the wire guide roller and which is termed a movable bearing. This is necessary in order to prevent mechanical overdetermination of the construction, resulting in unpredictable deformation.

Particularly at the moment of first contact between the wire web and the workpiece, in other words, on “saw engagement,” there is an abrupt change in mechanical and thermal loads. The arrangement of the wire web and the workpiece relative to one another is altered, and the component of this alteration in the direction of the wire guide roller axes means that the cutting kerfs, their sides formed by front side and back side of adjacent wafers, deviate from their planes perpendicularly to the wire guide roller axes; accordingly, the wafers become wavy. Wavy wafers are unsuitable for demanding applications.

There are methods known which are aimed at improving the plane-parallelism of the major faces of the wafers obtained by wire sawing.

U.S. Pat. No. 5,377,568 discloses a method wherein the position of a reference surface located externally on the wire guide roller, parallel to and in the vicinity of the end face of the movable bearing, is measured relative to the frame of the machine, and, by temperature control of the wire guide roller interior, a thermal increase in length or decrease in length of the wire guide roller is brought about, until the measured positional change of the reference surface has been compensated for. The positions of the wire sections of the wire web are displaced, on stretching of the wire guide roller in the axial direction, most favorably proportional to their distance from the fixed bearing. In fact, however, the warming of the wire guide roller is uneven, since it is warmed (thermal load change) on the outside (unevenly) and cooled from the inside, but the radial conduction of heat in the wire guide roller, because of the construction of the roller—not least as a result of the cooling labyrinth itself—is not identical for every axial position, and so the stretching of the wire guide roller along its axis is uneven.

JP 2003 145 406 A2 discloses a method wherein an eddy current sensor measures the position of a point externally on a wire guide roller and, in accordance with this positional measurement, changes the temperature of the cooling water which controls the temperature of the wire guide roller interior. The method only inadequately captures the change in the arrangement of workpiece to wire web as a consequence of the change in thermal or mechanical load.

KR 101 340 199 B1 discloses a method for wire sawing which uses wire guide rollers which are each rotatably mounted on a hollow shaft, where the hollow shaft can be heated or cooled at different temperature in a plurality of sections and hence can be stretched or contracted section by section in the axial direction. As a result, for a few sectors at least, the length of the wire guide roller is changed nonlinearly (nonuniformly) in the axial direction. The method, however, takes only an inadequate account of the change in arrangement of workpiece and wire web as a consequence of the change in thermal or mechanical load.

US 2012/0240915 A1 discloses a method for wire sawing which uses wire guide rollers in which the roller interior and one of their bearings, which bear the wire guide rollers rotatingly, are temperature controlled independently of one another by means of a cooling fluid. The method, however, fails to take account of the fact that thermal and mechanical deformations of the constructive elements of the wire saw are not constant and reproducible, with an additional exposure to time-dependent disrupting variables which go unaccounted.

WO 2013/079683 A1, lastly, discloses a wire sawing method wherein first of all the shapes of wafers which result for different temperatures of the wire guide roller bearings are measured, each of these shapes is stored with the respective associated bearing temperature, and then, in the subsequent cut, the bearing temperature is selected so as to correspond to the selection of stored shapes that best matches the desired target shape. This method does not account for the fact that the degree and behavior of the thermal response of the wire saw change from cut to cut, in accordance with a drift, or that disrupting variables that fluctuate over time act in the manner of a noise. Likewise remaining unaccounted for is the change in mechanical load that occurs during wire sawing.

Wafers of semiconducting material in particular are frequently subjected to other machining steps after wire sawing. Such machining steps may comprise the grinding of front and back side (sequentially or both sides simultaneously), the lapping of front and back side (both sides simultaneously), the etching of the semiconductor wafer, and the polishing of front and back side (usually carried out as sequential or simultaneous double-sided rough polishing and as single-sided fine polishing). A common feature of the single-sided or sequentially double-sided machining methods is that one side of the semiconductor wafers is held in a gripping device, by means of a vacuum chuck, for example, while the opposite side is being machined.

The thickness of a semiconductor wafer is typically small by comparison with its diameter. On being gripped, therefore, a semiconductor wafer undergoes elastic deformation such that the wafer-deforming forces (imposed load of the machining tool and tensioning forces, resulting from the applied vacuum, for example) and restoring deformation forces (bracing of the wafer) are in balance: the side of the semiconductor wafer that is being held conforms to the gripping device. Following removal of material from the machined side and detachment of the semiconductor wafer from the gripping device, the semiconductor wafer, which has become thinner by virtue of the machining, relaxes into its original shape. In other words, downstream machining steps do not in general improve the degree of plane-parallelism of front and back sides.

The object of the present invention lies in the overcoming of the outlined problems through the provision of a method which takes better account of the change in the arrangement of workpiece to wire web as a consequence of changes in thermal or mechanical load, and which provides wafers of low waviness.

### SUMMARY OF THE INVENTION

The foregoing objects and other objects are achieved by a method for slicing off a multiplicity of wafers from workpieces during a number of slicing operations by means of a wire saw which comprises a wire web of moving wire sections of a sawing wire which is stretched between two wire guide rollers, with each of the wire guide rollers being mounted between a fixed bearing and a movable bearing, said method comprising

feeding of one of the workpieces in the presence of a cooling lubricant during each one of the slicing operations along a feed direction against the wire web in the presence of hard substances which act abrasively on the workpiece;
temperature-controlling the fixed bearing of the respective wire guide roller during the slicing operations according to a temperature profile which mandates a temperature as a function of a depth of cut;
a first switching of the temperature profile in the course of the slicing operations from a first temperature profile with constant temperature course to a second temperature profile which is proportional to the difference of a first average shape profile and a shape profile of a reference wafer, with the first average shape profile being determined from wafers which have been sliced off in accordance with the first temperature profile.

### BRIEF DESCRIPTION OF THE DRAWINGS

FIG. 1 shows, in a perspective representation, features typical of a wire saw.

FIG. 2 shows a sectional representation through a wire guide roller and its mounting.

FIG. 3 shows the shape profile and the waviness profile (upper diagram) of a wafer not produced according to the invention, and the temperature profile (lower diagram) which was employed during the noninventive slicing operation.

FIG. 4 shows the shape profile and the waviness profile (upper diagram) of a wafer produced according to the invention, and the temperature profile (lower diagram) which was employed during the inventively implemented slicing operation.

### DETAILED DESCRIPTION OF THE PREFERRED EMBODIMENTS

Wafers sliced from a workpiece by the method of the invention are virtually unaffected by axial movements of the wire guide rollers as a consequence of thermal expansion of the fixed bearings. Consequently the deviation in shape of such wafers from a reference wafer is minimized.

The temperature of the fixed bearing may be controlled, for example, by resistance heating or by means of one or more Peltier cooling elements. With particular preference, however, the temperature control of the fixed bearing is accomplished by conducting a fluid through the fixed bearing of the respective wire guide roller during the slicing operations, with the temperature of the fluid for each of the slicing operations following a temperature profile which mandates the temperature of the fluid as a function of the depth of cut. Representative of the other embodiments, the further description of the method is directed to this preferred embodiment of the invention.

Provision is made preferably for a further switch of the temperature profile to a further temperature profile. The further temperature profile is proportional to the difference of a further average shape profile of previously sliced wafers and of the shape profile of the reference wafer, with the wafers sliced previously originating from at least 1 to 5 slicing operations which have immediately preceded a current slicing operation.

The determining of the first average shape profile and of the further average shape profile may be carried out on the basis of a wafer-based selection of wafers. In the case of a wafer-based selection, particular wafers of a slicing operation are employed for determining the respective average shape profile, by averaging, and others are excluded. For example, the only wafers considered for the averaging are those which have a certain position in the workpiece, as for instance only every 15th to 25th wafer along the length of the workpiece. Another possibility of wafer-based selection is to exclude wafers having the largest and smallest deviation of the shape profile from the average shape profile of all wafers from the slicing operation. An alternative possibility is to exclude from the averaging those wafers whose shape profile deviates by more than 1 to 2 sigma from the average shape profile of all wafers from the slicing operation.

The determining of the further average shape profile may instead also take place on the basis of a cut-based selection of wafers. In the case of a cut-based selection, all the wafers from at least one slicing operation are employed for determining a further average shape profile by averaging, and all wafers from at least one other slicing operation are excluded from the determination.

Furthermore, the determining of the further average shape profile may be carried out on the basis of a wafer-based and of a cut-based selection. In this case, at least one of the preceding slicing operations is selected and at least one of the preceding slicing operations is excluded, and at the same time certain wafers from the selected slicing operations are in each case selected and others are in each case excluded, and the wafers selected overall in this way are employed for the averaging.

Definitions which are useful for the understanding of the present invention, and also considerations and observations which resulted in the invention, are dealt with in the following sections of this description.

The surface of a wafer is made up of the front side, the back side, and the rim. The center of the wafer is its center of gravity.

The “regression plane” of a wafer is the plane for which the sum of the distances of all points on the front side and back side is minimal.

The “median area” of a wafer is the amount of the center points of all lines which join pairs of points which lie mirror-symmetrically to the regression plane and of which in each case one is located on the front side and one on the back side.

A wafer has an “area-based thickness defect” when the lengths of these lines change with the location on the front side and the back side.

A wafer has an “area-based shape defect” when the median area deviates from the regression plane.

“Reference wafer” is a wafer without area-based thickness defects and without area-based shape defects. The reference wafer chosen may also be a wafer having a particular thickness course or a particular shape course over the location on front and back sides if, correspondingly, a wafer which is convex or wedge-shaped, for example, is the desired objective of ingot division by wire sawing. A convex wafer is advantageous, for example, if the convexity counteracts an alteration in shape as a result of subsequent application of a braced layer on the front side (e.g., epitaxial layer) or back side (e.g., protective oxide).

“Feed direction” is the direction of the feeding of the workpiece to the wire web. The “area-based thickness profile” of a wafer denotes the thickness of a wafer as a function of the location on the regression plane.

The “center line” of a wafer is the line in the median area that extends in the feed direction through the center of the wafer.

The “thickness profile” of a wafer is the thickness of the wafer as a function of the location on the center line.

“Depth of cut” is a location on the center line and denotes the extent of the cutting kerf in the feed direction during the slicing operation.

The “shape profile” of a wafer is the course of the center line relative to the course of the center line of a reference wafer. The course of the center line is determined at measuring points along the depth of cut.

“Average shape profile” is a shape profile obtained by averaging the shape profiles of a plurality of wafers, with each shape profile being weighted identically for averaging (arithmetic averaging) or with the shape profile of certain wafers being given particular weighting on account of their position in the workpiece (weighted averaging).

“Shape deviation” denotes the deviation of a shape profile from a target shape profile, such as from the shape profile of a reference wafer, for example.

“Temperature profile” is the course of the temperature of a fluid as a function of the depth of cut, with the fluid being passed through the fixed bearing of the respective wire guide roller of the wire web for the purpose of temperature control of the fixed bearing during the slicing operation. As and when necessary, the temperature-controlling of the fixed bearing produces an expansion or contraction of the fixed bearing, the axial component of which displaces the movable bearing and also the axial position of the associated wire guide roller along the axis of rotation of the wire guide roller. This movement of the wire guide roller then counteracts the development of a deviation in shape.

The form of an arbitrary wafer may always be described through a combination of thickness profile and shape profile. TTV (total thickness variation, GBIR) is a characteristic which identifies the difference between the largest and the smallest values of the area-based thickness profile. Warp is a characteristic describing the deviation in shape, and identifies the sum of the respective greatest distances between the regression area and the median area in the direction of the front side of the wafer and in the direction of the back side of the wafer. Bow is a further such characteristic and identifies the distance between the regression plane and the median area in the center of the wafer. A further variable describing the deviation in shape is the waviness. It may be quantified as a waviness index Waved and is determined on the basis of a waviness profile, which is derived from the shape profile. Within a measurement window of a predetermined length, the characteristic wavelength, the maximum of the distance between the measuring points of the shape profile and the regression plane is determined. The start of the measuring window is moved along the depth of cut from measuring point to measuring point of the shape profile, and the determination of the maximum distance is repeated for each position of the measuring window. The amount of the maxima thus determined, plotted against the positions of the respectively associated measuring window, produces a profile of the waviness as a function of the depth of cut in relation to the characteristic wavelength, the waviness profile. The waviness index Waved is a measure of the reduced linear waviness, and identifies the maximum value of the waviness profile, disregarding values of regions of specified length at the start and at the end of the cut. In principle, the characteristic wavelength and the lengths of the disregarded regions can be chosen freely. The characteristic wavelength is preferably 2 mm to 50 mm and the specified lengths of the disregarded regions are preferably in each case 5 mm to 25 mm. In connection with the semiconductor wafer of the invention, which is yet to be described, a characteristic wavelength of 10 mm and lengths of the disregarded regions of in each case 20 mm are employed as a basis.

The abovementioned observations relate to the lap cutting of a straight circular-cylindrical ingot of silicon into wafers 300 mm in diameter. They are equally valid, however, for workpieces with different shapes, and for abrasive cutting. The surface of a straight circular cylinder comprises its circular base area (first end face), its top area congruent to the base area (second end face, opposite the first), and its cylindrical surface (amount of the points on the ingot at a maximum distance from the ingot axis). A straight circular cylinder possesses an ingot axis which is perpendicular to the base area and the top area and which passes through the center points thereof. The distance between base area and top area along this ingot axis is termed the height of the cylinder.

Firstly, it was observed that thickness profiles and shape profiles of wafers differ only slightly from one another with positions on the ingot axis which are close to one another. The thickness profiles of wafers with positions on the ingot axis which are further removed from one another, are indeed similar, but the shape profiles of such wafers differ sharply from one another. Consequently there can be no temperature profile which, if applied, would enable the shape of all the wafers of a workpiece to be made simultaneously planar. Through a displacement of the workpiece relative to the wire web that is dependent on the depth of cut, during the slicing operation, therefore, it will only be possible to obtain wafers with an approximately planar shape.

Secondly, it was observed that the shape profiles of wafers with the same positions on the ingot axis, and obtained by immediately successive slicing operations, usually differ only slightly from one another, whereas those of wafers with the same positions, but obtained by slicing operations between which there have been a plurality of intervening slicing operations carried out, deviate considerably from one another. Accordingly there can be no temperature profile which, if applied and retained, would leave the shape of the wafers with the same ingot position, and originating from successive slicing operations, unchanged over multiple slicing operations. Instead, the temperature profile may have to be changed at least slightly from one slicing operation to another in order to be able to obtain wafers having approximately planar shape over a multiplicity of slicing operations.

Thirdly, it was observed that the alteration of the shape profiles of identically positioned wafers, obtained by successive slicing operations, can be divided into a constant, predictable component and a nonconstant, spontaneous component. A temperature profile calculated in advance, consequently, will be able to take account only of the constant predictable component of the alteration, and the alteration in shape, despite application of the temperature profile, will be found to fluctuate in type and extent from one slicing operation to another and to not be predictable.

Fourthly, it was observed that the relative arrangement of workpiece and wire web, particularly at the moment of cut insertion, i.e., at the moment of the first contact between the workpiece and the wire web, though also over the entire slicing operation, is subject to a high change in thermal and mechanical load. It was found in particular that on the insertion of the sawing wire into the workpiece, a thermal output of several kW is transferred to the workpiece, to the wire guide rollers and to their bearings, and that the wire guide rollers, during a slicing operation, are subjected to a change in mechanical load with a force in the region of 10 kN in the axial transverse direction.

Fifthly, it was observed that the change in mechanical load leads to an increase in the friction in the bearings which connect the wire guide rollers to the frame of the machine. On the one hand there is an increase in the rolling friction of the rolling bodies because of the increased axial load, and on the other an increase in the friction as a consequence of tilting of the axis of the bearing bushes relative to the axis of the wire guide roller in the unloaded state. This tilting causes flexing of the bearing bush in the sleeve which is connected to the frame of the machine and into which the bearing bush is fitted. This flexing work leads to heating at the bearing bush/sleeve transition.

Consequently, the change in the bearing temperature, and the associated expansion of the bearing particularly in the axial direction to a misalignment of the axial position of the wire guide rollers, ought to be utilized in order, by means of cooling which acts in the vicinity of the outer periphery of the bearing sleeve, to reduce the warming and the associated change in axial position to a desired level.

Sixthly, it was observed that the warming of the fixed bearing of the wire guide roller of a wire saw leads, as a consequence of increased bearing friction or deformation (warming as a result of flexing work), to a displacement of the position of the wire guide roller in its axial position relative to the frame of the machine.

Seventhly, it was observed that wire sawing produces wafers having wavinesses which are pronounced in particular in the feed direction, and that it is practically not possible to reduce such wavinesses with lateral wavelengths in the range of around 10 mm through machining steps subsequent to wire sawing. In this respect, therefore, the waviness of a fully machined wafer is critically determined by the wire sawing itself.

Against the background of these observations, it is proposed, in the course of a number of slicing operations by means of the wire saw, that a sequence of slicing operations be provided which differ in that the temperature profile which mandates the temperature of the fluid which is passed through the fixed bearing of the respective wire guide roller of the wire web is different. The sequence of slicing operations begins, advantageously, after a change in the sawing system, in other words after a change in at least one feature of the wire saw, of the sawing wire or of the cooling lubricant. There is a change in the sawing system, for example, when a switch of wire guide rollers has taken place or when mechanical adjustments have been made to the wire saw. The first slicing operations in the sequence, which are called the initial cuts, consist preferably of 1 to 5 slicing operations. These slicing operations are carried out in accordance with a first temperature profile, which mandates a constant temperature course during the engagement of the wire sections into the workpiece.

From all wafers of the initial cuts, or from wafers of a wafer-based selection of the wafers of the initial cuts, shape profiles are determined. A first average shape profile is determined from the shape profiles by averaging, which may optionally be weighted. The first average shape profile is subsequently compared with the shape profile of a reference wafer, by subtracting the shape profile of a reference wafer from the first average shape profile. The shape deviation found accordingly corresponds approximately to an expectable shape deviation which wafers of a subsequent slicing operation would on average have if the subsequent slicing operation were to be carried out in accordance with the first temperature profile.

The shape deviation found therefore serves as a standard for a correction measure which is directed counter to the expectable shape deviation. The slicing operations following the initial cuts are therefore carried out not using the first temperature profile, but instead using a second temperature profile, which is proportional to the shape deviation found. If, for example, the shape deviation found suggests that, were the first temperature profile to be retained, wafers would be formed whose center line at a defined depth of cut would be offset on average by a certain amount in an axial direction of the wire guide rollers, then the second temperature profile, at the corresponding depth of cut, provides for a temperature of the fluid that results in the fixed bearing, by virtue of thermal expansion, displacing its associated wire guide roller by the same amount in the opposite direction. The shape deviation otherwise to be expected is counteracted by the temperature-controlling of the respective fixed bearing in accordance with the second temperature profile. Consequently, those slicing operations in the sequence that follow the initial cuts are carried out in accordance with the second temperature profile, and therefore the temperature profile is switched for the first time. The number of second slicing operations in the sequence, provided there is no further switch in the temperature profile, is preferably 1 to 15 slicing operations. In principle, however, all slicing operations which follow the first switch in the temperature profile can also be carried out using the second temperature profile, at least until there is a change in the sawing system.

With particular preference, however, the number of slicing operations which follow the initial cuts and which are carried out using the second temperature profile is limited to a number of 1 to 5 slicing operations, and all further slicing operations, at least until the onset of a change in the sawing system, are carried out using a further temperature profile. The further temperature profile is newly determined before each of the further slicing operations.

From all wafers of the 1 to 5 slicing operations immediately preceding the respective current slicing operation of the further slicing operations, or of wafers of a wafer-based selection of these wafers or of a cut-based selection of these wafers, or of a wafer-based and cut-based selection of these wafers, shape profiles are determined. A further average shape profile is determined from the shape profiles by averaging, which may optionally be weighted, before the current slicing operation. The further average shape profile is subsequently compared with the shape profile of the reference wafer, by subtracting the shape profile of the reference wafer from the further average shape profile. On the basis of the shape deviation found, a further temperature profile is determined, which is proportional to the shape deviation found. The current slicing operation is carried out using the further temperature profile. For each subsequent slicing operation, a further temperature profile is determined analogously. In other words, after the number of 1 to 5 slicing operations which follow the initial cuts, the temperature profile is switched with each further slicing operation.

A semiconductor wafer which is produced by a method of the invention and, where appropriate after subsequent machining steps, has a polished front and back side, is distinguished by a particularly low waviness.

A further subject of the invention, therefore, is a semiconductor wafer of monocrystalline silicon which comprises a waviness index Wav_{red} of not more than 7 μm, preferably of not more than 3 μm, if the diameter of the semiconductor wafer is 300 mm, or which comprises a waviness index Wav_{red} of not more than 4.5 μm, preferably not more than 2 μm, if the diameter of the semiconductor wafer is 200 mm. The characteristic wavelength for determining Wav_{red} is 10 mm, and the lengths of the disregarded regions at the start of cutting (cut engagement) and at the end of cutting (cut disengagement) are 20 mm in each case. A semiconductor wafer of the invention already has the waviness index Wav_{red} in the claimed range in the sawn state, i.e., in the unpolished state.

Fundamentally, the method of the invention is independent of the material from which the workpiece is made. However, the method is particularly suitable for slicing wafers of semiconductor material, and is preferably employed for slicing wafers of monocrystalline silicon. Correspondingly, a workpiece preferably has the shape of a straight circular cylinder having a diameter of at least 200 mm, preferably at least 300 mm. Other shapes, such as that of a cuboid or of a straight prism, however, are also contemplated. The method is also independent of the number of wire guide rollers of the wire saw. As well as the two wire guide rollers between which the wire web is stretched, there may be one or more further wire guide rollers provided.

The slicing of the wafers during a slicing operation is accomplished by abrasive cutting, with the supply to the wire sections of a cooling lubricant which is free of substances which act abrasively on the workpiece, or by lap cutting, with the supply to the wire sections of a cooling lubricant which consists of a slurry of hard substances. In the case of the abrasive cutting, the hard substances consist preferably of diamond and are fixed on the surface of the sawing wire by electroplate bonding or by bonding using synthetic resin, or by form-fitting bonding. In the case of the lap cutting, the hard substances consist preferably of silicon carbide and are slurried preferably in glycol or oil. The sawing wire preferably has a diameter of 70 μm to 175 μm and consists preferably of hypereutectoid pearlitic steel. Furthermore, the sawing wire may be provided along its longitudinal axis with a multiplicity of protuberances and indentations in directions perpendicular to the longitudinal axis.

It is preferable, furthermore, for the sawing wire to be moved, during a slicing operation, in a continual sequence of pairs of directional reversals, with each pair of directional reversals comprising a first moving of the sawing wire in a first longitudinal wire direction by a first length, and a second, subsequent moving of the sawing wire in a second longitudinal wire direction by a second length, with the second longitudinal wire direction being opposite to the first longitudinal wire direction and the first length being greater than the second length.

Preferably the sawing wire, on being moved by the first length, is supplied to the wire web with a first tensile force in the longitudinal wire direction from a first wire stock, and, on being moved by the second length, is supplied with a second tensile force in the longitudinal wire direction from a second wire stock, with the second tensile force being lower than the first tensile force.

Details of the invention are elucidated below with reference to drawings.

### LIST OF REFERENCE NUMERALS USED

1 Wire guide roller
2 Wire web
3 Sawing wire
4 Workpiece
5 Fixed bearing
6 Movable bearing
7 Frame of machine
8 Covering
9 Channel
10 Control unit
11 Direction of movement of movable bearing
12 Shape profile
13 Waviness profile
14 Temperature profile
15 Temperature profile
16 Shape profile
17 Waviness profile
18 Temperature profile
19 Temperature profile
20 Cut engagement region
21 Cut disengagement region
22 Cut engagement region
23 Cut disengagement region
24 Maximum in the inner subregion of 13

### DETAILED DESCRIPTION OF WORKING EXAMPLES OF THE INVENTION

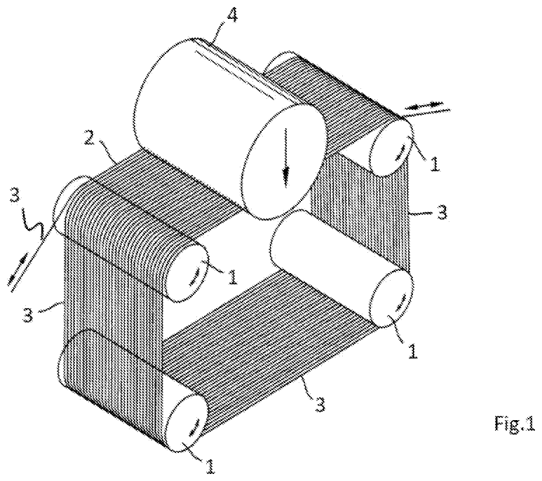

FIG. 1 shows features typical of a wire saw. These include at least two wire guide rollers 1, which carry a wire web 2 composed of wire sections of a sawing wire 3. To slice wafers, a workpiece 4 is fed against the wire web 2 in the feed direction symbolized by an arrow.

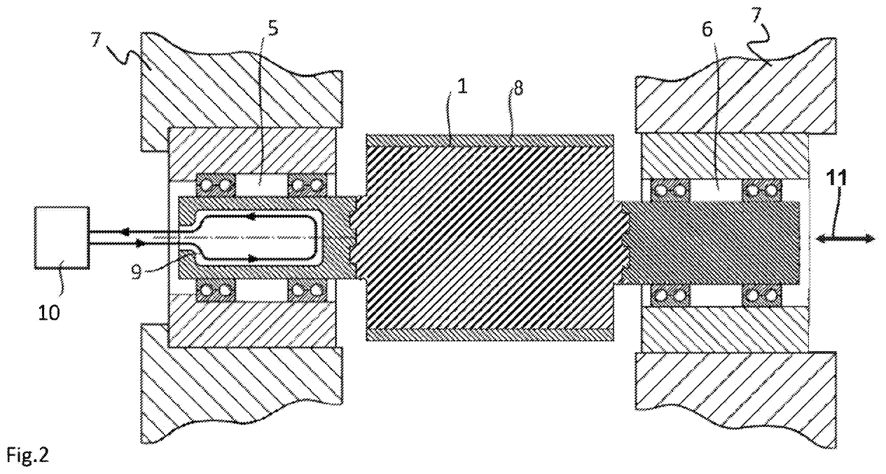

As shown in FIG. 2, the wire guide roller 1 is mounted between a fixed bearing 5 and a movable bearing 6. Fixed bearing 5 and movable bearing 6 are supported on a frame 7 of the machine. The wire guide roller 1 carries a covering 8 which is provided with grooves in which the sawing wire 3 runs. The fixed bearing 5 comprises a channel 9 through which a fluid is passed for the purpose of temperature control of the fixed bearing 5. If the temperature of the fluid is increased, the thermal expansion of the fixed bearing 5 produces an axial displacement of the wire guide roller 1 in the direction of the movable bearing 6, and the movable bearing 6 moves in the direction—marked with a double arrow 11—of the axis of the wire guide roller relative to the machine frame 7. If the temperature of the fluid is reduced, a displacement is produced of the wire guide roller 1 and of the movable bearing 6 in the opposite direction. In accordance with the invention, the temperature of the fluid is mandated as a function of the depth of cut by a temperature profile, and the temperature profile is changed at least once in the course of a number of slicing operations. A control unit 10, which communicates with a heat exchanger and a pump, ensures that the fluid passed through the fixed bearing 5 has the temperature required by the respective temperature profile when a certain depth of cut is reached.

### Inventive and Comparative Examples

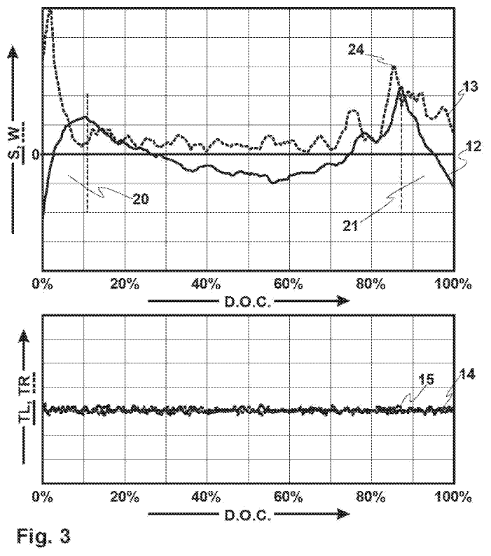

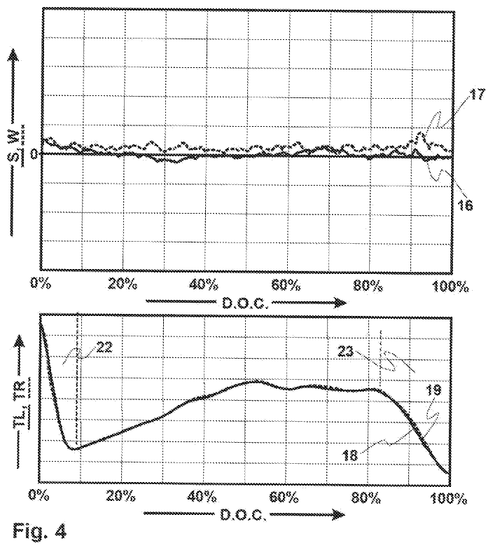

The invention is illustrated below using a noninventive, comparative example (FIG. 3) and an inventive example (FIG. 4).

FIG. 3 shows, in the upper half, the shape profile 12 of a semiconductor wafer, sliced by wire lap cutting, of monocrystalline silicon with a diameter of 300 mm, over the depth of cut (D.O.C). The cutting operation took place using a steel wire 175 μm in diameter, over the course of about 13 hours, employing silicon carbide (SiC) having a mean grain size of about 13 μm (FEPA F-500), slurried in a carrier fluid of dipropylene glycol. During the cutting operation, the temperatures for the cooling of the fixed bearings were kept constant at values which had been determined, from prior cutting operations, as being ideal for the acquisition of extremely planar semiconductor wafers. The lower diagram of FIG. 3 shows the temperature profile 14, as a function of the depth of cut, of the cooling water temperature of the left-hand fixed bearing (TL=temperature left; continuous line) and the corresponding temperature profile 15 of the cooling water temperature of the right-hand fixed bearing (TR=temperature right; dashed line) of the two wire guide rollers carrying the wire web.

The distance between two horizontal lattice lines in the lower diagram is 1° C. In fact, therefore, the temperature was kept very constant, with target/actual deviations of less than 0.1° C. The shape profile 12 obtained in this comparative example for the semiconductor wafer (S=shape (profile); continuous line), however, is very nonplanar. In particular, the semiconductor wafer exhibits a severe deformation in the cut engagement region 20, in other words within the first 10% of the depth of cut, this deformation being referred to as cut engagement wave, and exhibits a severe deformation in the cut disengagement range 21, in other words within the last approximately 10% of the depth of cut, this deformation being referred to as cut disengagement wave. The waviness profile 13 (W=waviness; dashed line) which is derived from the shape profile 12, and which depicts the amount of the difference in the deformation of the semiconductor wafer within a measuring window which moves along the depth of cut, shows severe deflections in the cut engagement region 20 and in the cut disengagement region 21.

FIG. 4 shows, in the upper diagram, the shape profile 16 and its derived waviness profile 17 for a semiconductor wafer sliced with a method of the invention, and, in the lower diagram, the temperature profiles 18 and 19 of the left-hand and the right-hand fixed bearings of the wire guide rollers carrying the wire web. To produce the semiconductor wafer having the properties according to FIG. 4, first of all five slicing operations were carried out using a constant temperature profile, in accordance with the lower half of FIG. 3, and the shape profiles of the resulting semiconductor wafer from each slicing operation were averaged on a spot-check basis (every 15th semiconductor wafer, from the start to the end of the ingot), with the shape profiles of the semiconductor wafers adjacent to each of the end faces of the ingot being disregarded (wafer-based selection), and then the resultant wafer-based average shape profiles of each slicing operation were averaged over the five slicing operations (cut-based selection).

The resultant wafer-based and cut-based average shape profile was multiplied by a machine-specific constant (in ° C./μm), determined experimentally beforehand, which indicates the sensitivity of the change (in μm) in shape profile per temperature alteration of the fixed bearing (in ° C.), to give a first, nonconstant temperature profile for the depth-of-cut-dependent fixed-bearing temperature control, and a further slicing operation was carried out using this profile. This operation produced semiconductor wafers having a wafer-based average shape profile which was already significantly more planar than the wafer-based and cut-based average shape profile of the first five slicing operations employing the constant temperature profile. Because the control variable, namely the first, nonconstant temperature profile, for this slicing operation was obtained by regression to the constant temperature profile, the application of this temperature profile may also be termed a regressive feedback control.

The slicing operation which produced the semiconductor wafer whose shape profile is shown by the upper diagram of FIG. 4 was carried out, finally, employing a temperature profile which was computed from the deviation in the wafer-based average shape profile of the preceding slicing operation from the shape profile of a reference wafer. This further temperature profile is shown in the lower diagram of FIG. 4. In the cut engagement region 22, within the first 10% of the depth of cut, the temperature profile exhibits significantly increased temperatures, and in the cut disengagement region 23 within the last approximately 10% of the depth of the cut it exhibits significantly reduced temperatures, with the consequence that the cut engagement wave in the cut engagement region 20 and the cut disengagement wave in the cut disengagement region 21, in line with the upper diagram of FIG. 3, are not observed.

Because the control variable, namely the further temperature profile, differs from that of the preceding slicing operation only in the change corresponding to the difference (increment) between the wafer-based average shape profile of the slicing operation before the preceding one, and that of the preceding slicing operation, the application of the further temperature profile may also be designated as incremental feedback control.

The machine-specific constant which is employed for calculating the temperature profiles indicates the number of micrometers by which the shape profile is altered when the fixed bearing temperature is raised or lowered by one degree Celsius, and is determined by the efficiency of the cooling—that is, for example, by the supply temperature—and by the cooling performance of the heat exchanger which supplies the cooling water, and by the throughput (cross section) of the flow of cooling water. Given that all of these variables are subject to fluctuations and, moreover, are specific to each wire saw, the machine-specific constant can be determined only with substantial inaccuracy.

The sign of the machine-specific constant is dictated by which of the two sides of the semiconductor wafer is defined as the front and which as the back side. In the present examples the ingot of semiconductor material was always oriented with the seed end (for the ingot with two end faces, the end face whose position was closer to a monocrystalline seed crystal during the production of the ingot) in the direction of the wire guide roller fixed bearing, and with the second end face oriented in the direction of the movable bearing, and the front side of the semiconductor wafer was specified as the surface pointing toward the seed end, with the back side of the semiconductor wafer being the semiconductor wafer surface pointing away from the seed end. In agreement with the representations in FIG. 3 and FIG. 4, the front side of the semiconductor wafer points upward, and its back side downward. In this arrangement, the sign for the conversion of the average shape profile into the temperature profile is negative. In the case of a reversed orientation of the ingot in the wire saw, the machine-specific constant would be positive.

The particular efficiency of, in particular, the incremental regulation according to the invention, then, is that it is not necessary for the machine-specific constant to be known precisely, since the fundamental quality of an incremental regulation is that of converging toward the target value (the shape profile of the reference wafer), provided the proportionality factor—that is, the machine-specific constant—selected is not too high. If it were to be too high, the regulation would oscillate and would not converge as desired. Consequently, even with just an estimated value for the constant, the semiconductor wafers obtained in the course of a few slicing operations always have very planar shape profiles, provided this estimated value is assumed more to be too small in terms of amount.

For different wire saws, therefore, it is possible in particular to assume the same estimated value for the machine-specific constant, preferably a constant having an amount in the range from 0.2 to 5 μm/° C. The sign of the machine-specific constant is dictated, as described, from the determination as to the directions in which the front side and back side of the semiconductor wafers are pointing in relation to the ingot installed in the wire saw. Differences between wire saws with different actual constants then come about only in the rate of the convergence, but not in the achievable degree of plane-parallelism of the semiconductor wafers. Their residual unevennesses are now only determined by the unpredictable fluctuations in the respective slicing operation that occur from one slicing operation to another (noise variables).

The waviness index Wav_{red} is determined starting from the shape profile of a wafer, in the manner explained below using, as the example, the shape profiles 12 in FIGS. 3 and 16 in FIG. 4. From such a shape profile, within a measuring window having a characteristic wavelength of 10 mm, in the direction of the depth of cut (D.O.C.), the amount is determined of the difference between maximum and minimum of the shape profile within the measuring window. The position of the start of the measuring window is stipulated along the depth of cut bit by bit to each measuring point of the shape profile, and the amount of the difference is determined for each of these positions. The difference amounts thus obtained are plotted as a function of the depth of cut, with the position of the start of the measuring window indicating the respective depth of cut. Accordingly a waviness profile is obtained, represented for example by the curves 13 in FIGS. 3 and 17 in FIG. 4. The waviness index Wav_{red} is determined from the waviness profile, by disregarding the values of the difference amounts within a length of 20 mm at both the start of cut and the end of cut, and, from the remaining difference amount values, defining the maximum as the waviness index Wav_{red}.

Correspondingly, starting from the shape S of the shape profile 12 in FIG. 3, the waviness index Wav_{red} of the semiconductor wafer not produced in accordance with the invention is about 12 μm, corresponding to the maximum 24 of the waviness W of the waviness profile 13 and taking account of an ordinate grid spacing of 4 μm. Starting from the shape profile 16 in FIG. 4, the waviness index Wav_{red} of the semiconductor wafer produced in accordance with the invention is about 3 μm, corresponding to the maximum of the waviness W of the waviness profile 17 and taking account of an ordinate grid spacing of 4 μm.

The above description of illustrative embodiments should be considered to be by way of example. The disclosure thus made firstly enables the skilled person to comprehend the present invention and the associated advantages, and secondly, within the understanding of the skilled person, also encompasses obvious alterations and modifications to the structures and methods described. Therefore, all such alterations and modifications and equivalents as well shall be covered by the scope of protection of the claims.

1.-19. (canceled)

20. A method for slicing a multiplicity of wafers from workpieces during a number of slicing operations by a wire saw comprising a wire web of moving wire sections of sawing wire stretched between two wire guide rollers, each of the wire guide rollers mounted between a fixed bearing and a movable bearing, said method comprising:
feeding a workpiece during each of the slicing operations along a feed direction against the wire web in the presence of hard substances which act abrasively on the workpiece in the presence of a working fluid;
temperature-controlling the wire guide roller fixed bearing during the slicing operations according to a temperature profile which mandates a temperature as a function of a depth of cut of the workpiece;
a first switching of the temperature profile in the course of the slicing operations from a first temperature profile with constant temperature course to a second temperature profile which is proportional to the difference of a first average shape profile and a shape profile of a reference wafer, with the first average shape profile determined from wafers which have been sliced in accordance with the first temperature profile, and
further switching the temperature profile to a further temperature profile, which is proportional to the difference of a further average shape profile of previously sliced wafers and of the shape profile of the reference wafer, with the previously sliced wafers originating from at least 1 to 5 slicing operations which have immediately preceded a current slicing operation, and the further average shape profile determined on the basis of a cut-related selection of wafers.

21. The method of claim 20, further comprising using the first temperature profile during a first of the slicing operations which takes place after a change in at least one feature of the wire saw, of the sawing wire or of the working fluid.

22. The method as claimed in claim 20, further comprising determining the further average shape profile on the basis of a wafer-based and of a cut-based selection of wafers.

23. The method as claimed in claim 21, further comprising determining the further average shape profile on the basis of a wafer-based and of a cut-based selection of wafers.

24. The method of claim 20, further comprising determining the first average shape profile and the further average shape profile on the basis of a weighted averaging of the shape profile of wafers.

25. The method of claim 20, wherein the sawing wire is a hypereutectoid pearlitic steel wire.

26. The method of claim 20, wherein the sawing wire has a diameter of 70 μm to 175 μm.

27. The method as claimed in claim 22, wherein the sawing wire (3) is provided along a longitudinal wire axis with a multiplicity of protuberances and indentations in directions perpendicular to the longitudinal wire axis.

28. The method of claim 20, further comprising supplying a cooling lubricant as a working fluid to the wire sections during the slicing operations, with hard substances comprising diamond fixed on the surface of the sawing wire by electroplate bonding, by synthetic resin bonding or by form-fitting bonding, wherein the cooling lubricant is free of substances which act abrasively on the workpiece.

29. The method of claim 20, comprising supplying a working fluid in the form of a slurry of hard substances in glycol or oil to the wire sections during slicing operations, with the hard substances comprising silicon carbide.

30. The method of claim 20, further comprising moving the sawing wire in a continual sequence of pairs of directional reversals, with each pair of directional reversals comprising a first moving of the sawing wire in a first longitudinal wire direction by a first length, and a second, subsequent moving of the sawing wire in a second longitudinal wire direction by a second length, with the second longitudinal wire direction being opposite to the first longitudinal wire direction and the first length being greater than the second length.

31. The method of claim 20, wherein the sawing wire during movement into the by the first length is supplied to the wire web with a first tensile force in the longitudinal wire direction from a first wire stock, and during movement by the second length is supplied with a second tensile force in the longitudinal wire direction from a second wire stock, and with the second tensile force being lower than the first tensile force.

32. The method of claim 20, wherein the workpiece consists of a semiconductor material.

33. The method of claim 20, wherein the workpiece has the form of a straight prism.

34. The method of claim 20, wherein the workpiece has the form of a straight circular cylinder.

35. A semiconductor wafer of monocrystalline silicon, which, immediately following separation from a workpiece by sawing in a wire saw having a wire web of a plurality of parallel wire sections, comprises a waviness index Wav_{red} of not more than 7 μm and a diameter of 300 mm, or a waviness index Wav_{red} of not more than 4.5 μm and a diameter of 200 mm, wherein a characteristic wavelength of 10 mm and disregarded regions at the start of cutting and at the end of cutting of 20 mm are employed as a basis for determining the waviness index Wav_{red}.

36. The semiconductor wafer of claim 32, which comprises a waviness index Wav_{red} of not more than 3 μm and a diameter of 300 mm, or a waviness index Wav_{red} of not more than 2 μm and a diameter of 200 mm.
